(19) United States
(12) Patent Application Publication
(10) Pub. No.: US 2026/0027885 A1
(43) Pub. Date: Jan. 29, 2026

(54) VEHICLE BOTTOM STRUCTURE

(71) Applicant: TOYOTA JIDOSHA KABUSHIKI KAISHA, Toyota-shi (JP)

(72) Inventors: Fumio NOMIZO, Toyota-shi (JP); Katsunori Higashihara, Toyota-shi (JP); Kazuki Funahashi, Nagoya-shi (JP); Yuuji Mizutani, Toyota-shi (JP)

(73) Assignee: TOYOTA JIDOSHA KABUSHIKI KAISHA, Toyota-shi (JP)

(21) Appl. No.: 19/096,956

(22) Filed: Apr. 1, 2025

(30) Foreign Application Priority Data
Jul. 26, 2024 (JP) 2024-120982

(51) Int. Cl. B60K 1/04

(52) U.S. Cl. CPC B60K 1/04; B60K 2001/0438

(57) ABSTRACT

The vehicle bottom structure includes a battery pack, an outer cross member disposed below the battery pack and spaced apart in the vehicle front-rear direction, a plurality of reinforcing members, and a share panel. The lower walls of the share panel, the reinforcing member, and the outer cross member are fastened by bolts. The reinforcing member includes a body having a recess. Bolt through holes are provided in the recesses at intervals in the vehicle width direction. The reinforcing member includes a front flange and a rear flange positioned forward and rearward of the non-bolt region between adjacent bolt through holes. The non-bolt region, the front flange, and the rear flange are welded to the share panel. Both ends in the front-rear direction of the lower surface of the body are located outward from both ends in the front-rear direction of the lower wall of the outer cross member.

### CROSS-REFERENCE TO RELATED APPLICATION

This application claims priority to Japanese Patent Application No. 2024-120982 filed on Jul. 26, 2024. The disclosure of the above-identified application, including the specification, drawings, and claims, is incorporated by reference herein in its entirety.

### BACKGROUND

### 1. Technical Field

The present specification discloses a bottom structure of an electrified vehicle in which a battery pack is mounted below a floor.

### 2. Description of Related Art

Electrified vehicles such as battery electric vehicles (BEVs) are known. An electrified vehicle includes a battery pack that supplies electric power to a travel motor. The battery pack is mounted below the floor of a vehicle cabin.

Japanese Unexamined Patent Application Publication No. 2023-87250 (JP 2023-87250 A) discloses a battery case that is mounted under the floor of a vehicle cabin of a battery electric vehicle and in which a battery is stored.

### SUMMARY

An electrified vehicle includes a battery pack mounted below the floor. The electrified vehicle includes a plurality of outer cross members disposed below the battery pack at intervals in the vehicle front-rear direction. The electrified vehicle includes a share panel disposed below the outer cross members to cover the battery pack from below. The share panel forms a vehicle bottom surface below the floor.

The battery pack has a case that houses a battery module. Each of the outer cross members has a hat-shaped cross section open upward, extends in the vehicle width direction, and is attached to the outer surface of a bottom plate of the case of the battery pack. A lower wall (web) of each of the outer cross members and the share panel are stacked and fastened by bolts. That is, the share panel is held by the outer cross members at intervals in the vehicle front-rear direction.

When an object collides with the share panel from the vehicle lower side, the share panel deflects upward between two fastening points (fastening points with two outer cross members) of the share panel in the vehicle front-rear direction. This may cause the share panel to approach the battery pack and damage the battery pack. It is desired to reduce the amount of upward deflection of the share panel when an object collides with the share panel from the vehicle lower side.

The present disclosure provides a vehicle bottom structure capable of reducing upward deflection of a share panel when an object collides with the share panel from the vehicle lower side.

A vehicle bottom structure of the present disclosure includes:
a battery pack including a case that houses a battery module inside, the battery pack being mounted below a floor;
a plurality of outer cross members located below a bottom plate of the case and disposed at intervals in a vehicle front-rear direction; and
a share panel that is disposed below the outer cross members and covers the bottom plate of the case.

Each of the outer cross members has a hat-shaped cross section open upward, extends in a vehicle width direction, and is attached to an outer surface of the bottom plate of the case.

A reinforcing member extending in the vehicle width direction is disposed between a lower wall of each of the outer cross members and the share panel.

The share panel, the reinforcing members, and the lower walls of the outer cross members are stacked and fastened by bolts at intervals in the vehicle width direction.

The reinforcing member includes a body having bolt through holes through which the bolts pass, and a front flange and a rear flange projecting in the vehicle front-rear direction from a non-bolt region between the bolt through holes of the body that are adjacent to each other.

A central portion of the body of the reinforcing member in the vehicle front-rear direction includes a thinned upper surface that defines a recess extending in the vehicle width direction.

The non-bolt region in the recess of the body of the reinforcing member, the front flange, and the rear flange are welded to the share panel.

Both ends of a lower surface of the body of the reinforcing member in the vehicle front-rear direction are located outward of both ends of the lower wall of the outer cross member in the vehicle front-rear direction.

In the above configuration, the distance between the fulcrums of bending moment of the share panel when an object collides with the share panel from the vehicle lower side is shorter than the distance in a case where the share panel is directly fastened to the lower wall of the outer cross member. That is, the distance between the fulcrums of the bending moment of the share panel is shortened by the body of each reinforcing member whose both ends in the vehicle front-rear direction are located outward of those of the outer cross member. Thus, it is possible to reduce the upward deflection of the share panel.

In the above configuration, the non-bolt region in the recess of the body of the reinforcing member, the front flange, and the rear flange are welded to the share panel. Therefore, when an object collides with the share panel from the vehicle lower side, it is possible to restrict movement of the share panel toward the colliding object relative to the reinforcing member. As a result, it is possible to reduce the upward deflection of the share panel.

In the above configuration, the central portion of the upper surface of the body of the reinforcing member (referred to as “reinforcing member body”) in the vehicle front-rear direction is thinned to define the recess extending in the vehicle width direction. The front flange and the rear flange are present forward and rearward of the non-bolt region of the reinforcing member body. The flanges may be omitted forward and rearward of the bolt region (region where the bolt through hole is located) of the reinforcing member body. Therefore, the weight of the reinforcing member can be reduced.

In the vehicle bottom structure of the present disclosure,
the lower wall of the outer cross member includes a projection that projects downward,
the recess of the body of the reinforcing member receives the projection of the outer cross member,
putty that fills a space between an inner surface of the recess of the body of the reinforcing member and an outer surface of the projection of the outer cross member is disposed in the non-bolt region in the recess, and
the projection of the outer cross member is detachable from the putty.

In this configuration, it is possible to restrict movement of the non-bolt region of the body of the reinforcing member (reinforcing member body) relative to the outer cross member when an object collides with the share panel from the vehicle lower side. Therefore, it is possible to suppress the approach of the share panel to the battery pack. The putty (gap filler) is disposed between the inner surface of the recess of the reinforcing member body and the outer surface of the projection of the outer cross member. Therefore, rattling between the non-bolt region of the reinforcing member body and the outer cross member can be suppressed. The projection of the outer cross member is detachable from the putty. Therefore, the share panel can be removed from the outer cross member by releasing the bolt fastening of the outer cross member and the share panel. Thus, it is possible to improve the maintainability of the vehicle.

In the vehicle bottom structure of the present disclosure, the recess of the body of the reinforcing member includes:
a first recess; and
a second recess provided in a central portion of the first recess in the vehicle front-rear direction.

In this configuration, it is possible to suppress an outward overflow of the putty in the recess of the body of the reinforcing member (reinforcing member body) at the time of manufacturing the vehicle. That is, when the putty is disposed in the recess of the reinforcing member body at the time of manufacturing the vehicle, the second recess is filled with softened putty. The reinforcing member and the share panel are attached to the outer cross member. In this way, the projection of the outer cross member enters the putty in the second recess of the reinforcing member body, and then the putty hardens. With the above configuration, when the projection of the outer cross member enters the putty in the second recess of the reinforcing member body, the putty overflowing from the second recess can be received by the first recess. Therefore, it is possible to suppress the outward overflow of the putty from the reinforcing member.

According to the technology of the present disclosure, it is possible to reduce the upward deflection of the share panel when an object collides with the share panel from the vehicle lower side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a perspective view schematically illustrating a top surface of a share panel of a vehicle of an embodiment;

FIG. 1B shows a part of the reinforcing member in an enlarged manner;

FIG. 2 is a cross-sectional view taken along II-II line in FIG. 1A;

FIG. 3 is a cross-sectional view of a bolt region of a reinforcing member in another embodiment;

FIG. 4 is a cross-sectional view of a non-bolt region of a reinforcing member in another embodiment; and

FIG. 5 is a view for explaining a method of disposing a putty in a recess of a reinforcing member.

### DETAILED DESCRIPTION OF EMBODIMENTS

Hereinafter, embodiments will be described with reference to the drawings. In all the drawings, equivalent elements are denoted by the same reference numerals, and redundant description is omitted. In the following description, unless otherwise specified, the terms indicating the front-rear, right-left, and up-down, etc. directions indicate the directions related to a vehicle. In the drawings, the direction of the arrow FR indicates the front side, the direction of the arrow UP indicates the upper side, and the direction of the arrow RH indicates the right side.

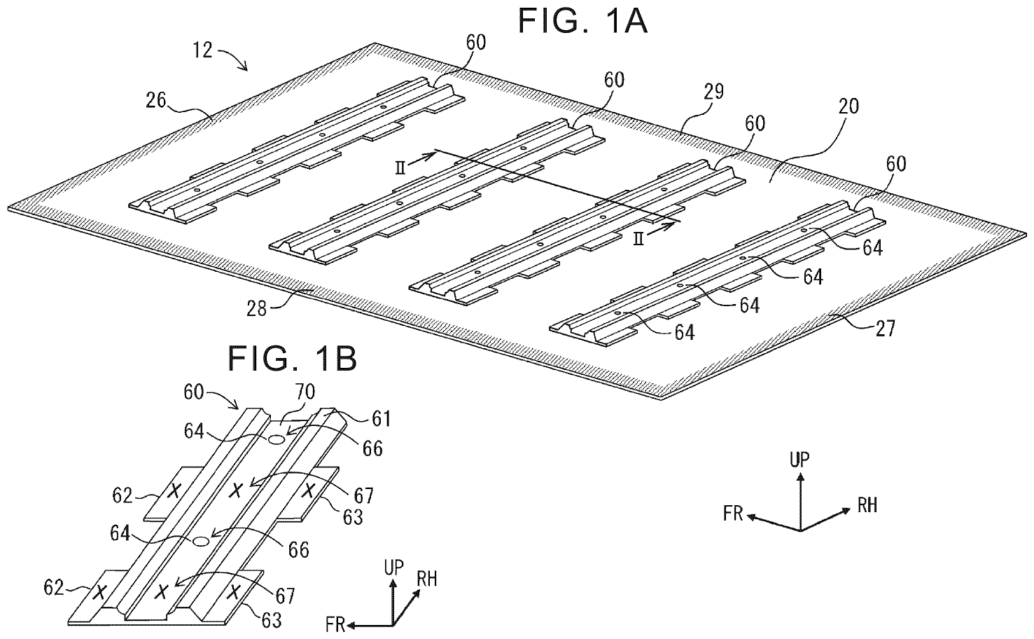

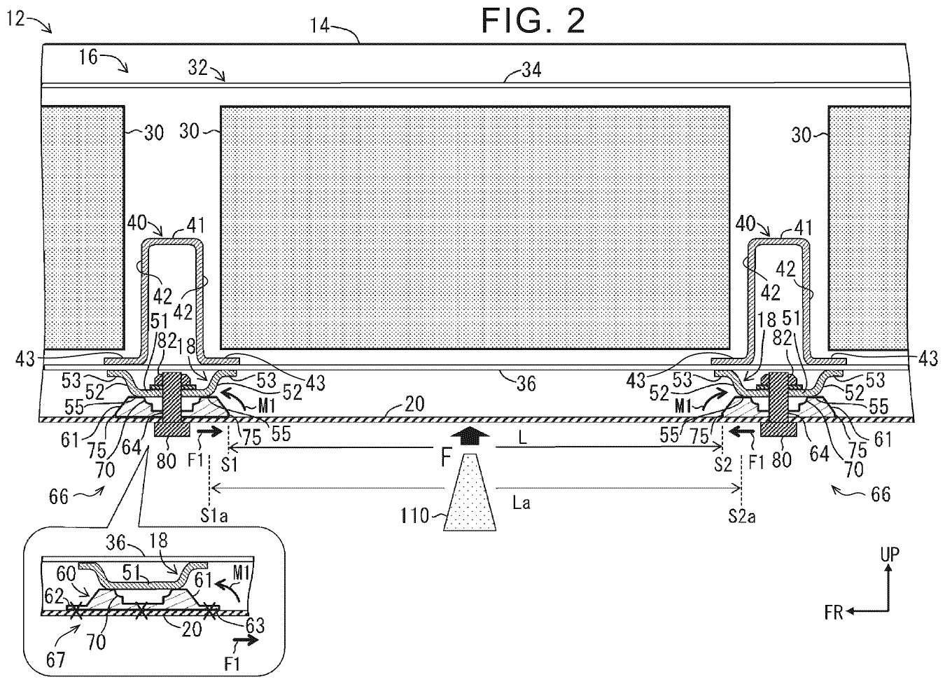

FIG. 1A is a perspective view schematically illustrating a top surface of the share panel 20 of the vehicle 12. FIG. 1B shows a part of the reinforcing member 60 in an enlarged manner. FIG. 2 is a cross-sectional view taken along II-II line in FIG. 1A and also shows the battery pack 16 and the floor 14 located above the share panel 20. The vehicles 12 are electrified vehicle such as battery electric vehicle, hybrid battery electric vehicle, and plug-in hybrid battery electric vehicle. Electrified vehicle includes a battery pack 16 that supplies electric power to a motor (not shown) serving as a power source.

As shown in FIG. 2, the battery pack 16 is mounted below the floor 14 of the vehicle cabin. The vehicle 12 includes a share panel 20 that covers the battery pack 16 from below. The share panel 20 forms a vehicle bottom surface below the floor 14.

The battery pack 16 includes a plurality of battery modules 30 and a case 32. The battery module 30 includes a battery stack in which a plurality of battery cells are stacked. The case 32 is an outer shell of the battery pack 16. The case 32 houses a plurality of battery modules 30 therein. The case 32 includes a lower case and an upper case. The lower case has, for example, a bathtub shape, and the upper case has, for example, an inverted bathtub shape (a shape in which the bathtub is inverted). An upper case is fixed on the lower case. FIG. 2 shows the bottom plate 36 of the lower case and the top plate 34 of the upper case.

A plurality of inner cross members 40 are attached to the upper surface of the bottom plate 36 of the case 32. The inner cross member 40 is disposed in a gap between the adjacent battery modules 30 and extends in the vehicle width direction (vehicle left-right direction). The inner cross member 40 is a folded plate member having a hat-shaped cross section. The inner cross member 40 includes a web 41, a pair of flanges 42 erected at opposite ends of the web 41, and a pair of arms 43 extending outward from tips of the pair of flanges 42. The arm 43 of the inner cross member 40 is joined to the upper surface of the bottom plate 36.

The vehicle 12 includes a plurality of outer cross members 18. The plurality of outer cross members 18 are located below the bottom plate 36 of the case 32 and are spaced apart from each other in the vehicle front-rear direction. The outer cross member 18 has a hat-shaped cross section opened upward and extends in the vehicle width direction. The outer cross member 18 is a folded plate member. The outer cross member 18 includes a lower wall 51 (web), a pair of flanges 52 erected on both side ends of the lower wall 51, and a pair of arms 53 extending outward from the tips of the pair of flanges 52. The arm 53 of the outer cross member 18 is joined to the lower surface of the portion of the bottom plate 36 to which the arm 43 of the inner cross member 40 is joined. A weld nut 82 is welded to the inside of the outer cross member 18.

The vehicle 12 includes a plurality of reinforcing members 60 (reinforcement). The reinforcing member 60 is a substantially plate-shaped member that is elongated and extends in the vehicle width direction. The reinforcing member 60 is manufactured by performing a cutting process on, for example, an extruded metal material, a steel material, a resin material, or the like. The reinforcing member 60 is disposed between the lower wall 51 of each outer cross member 18 and the share panel 20. As shown in FIG. 1A, the reinforcing member 60 is welded to the upper surface of the share panel 20 at a distance from each other in the vehicle front-rear direction. Each reinforcing member 60 is located on the vehicle width direction inner side of each of the left end 28 and the right end 29 of the share panel 20.

The reinforcing member 60 includes a body 61 (see FIG. 1B). The body 61 is provided with a plurality of bolt through holes 64 spaced apart in the vehicle width direction (vehicle left-right direction). The body 61 has a recess 70 extending in the vehicle width direction when the upper surface of the center portion in the front-rear direction is thinned out. The plurality of bolt through holes 64 are formed in the recess 70 of the body 61. A bolt 80 (see FIG. 2) inserted from below the share panel 20 is passed through each bolt through hole 64. In the present disclosure, the body 61 of the reinforcing member 60 is also referred to as the reinforcing member body 61.

Hereinafter, a region in which the bolt through hole 64 of the reinforcing member body 61 is provided is referred to as a bolt region 66. Bolt regions 66 are shown in FIG. 1B. A region between adjacent bolt through holes 64 of the reinforcing member body 61 is referred to as a non-bolt region 67. That is, a region in which the bolt through hole 64 is not provided in the reinforcing member body 61 is referred to as a non-bolt region 67. In II-II section of FIG. 2, the bolt regions 66 of the two reinforcing members 60 are shown. The blowout of FIG. 2 shows a cross-section of the non-bolt region 67 of one reinforcing member 60.

The reinforcing member 60 includes a front flange 62 and a rear flange 63, as shown in FIG. 1B. The front flange 62 and the rear flange 63 protrude from the non-bolt region 67 of the reinforcing member body 61 in the vehicle front-rear direction. The flange is omitted in the front and rear of the bolt region 66 of the reinforcing member body 61. The non-bolt region 67, the front flange 62, and the rear flange 63 in the recess 70 of the reinforcing member body 61 are welded to the upper surface of the share panel 20. In the figures, the cross marks indicate the welding points.

The share panel 20 is a bottom plate of a vehicle, and has a substantially rectangular shape whose longitudinal direction is the vehicle front-rear direction in a plan view. The share panel 20 may be made of, for example, an aluminum material, a high-tensile material (steel material having high tensile strength), or the like. As shown in FIG. 1A, the share panel 20 includes a front end 26, a rear end 27, a left end 28, and a right end 29. Although not shown, the front end 26, the rear end 27, the left end 28, and the right end 29 are machined into a desired shape so as to be attachable to a skeletal member of a vehicle. The front end 26, the rear end 27, the left end 28, and the right end 29 of the share panel 20 are respectively attached to the skeleton members of the front portion of the vehicle body, the rear portion of the vehicle body, the left portion of the vehicle body, and the right portion of the vehicle body.

As shown in FIG. 2, the share panel 20, the reinforcing member 60, and the lower wall 51 of the outer cross member 18 are stacked and fastened with bolts 80. The bolt 80 passes through the share panel 20. The bolt 80 passes through the bolt through hole 64 of the reinforcing member 60 and passes through the lower wall 51 of the outer cross member 18. The bolt 80 is fastened to the weld nut 82 of the outer cross member 18. The reinforcing member 60 is provided with fastening points (bolt regions 66) by the bolt 80 and the nut 82 side by side at intervals in the vehicle width direction.

As shown in FIG. 2, in each of the plurality of reinforcing members 60, both ends 75 in the vehicle front-rear direction on the lower surface of the reinforcing member body 61 are located outward from both ends 55 in the vehicle front-rear direction of the lower wall 51 of the outer cross member 18.

According to the embodiment described above, as shown in FIG. 2, when the object 110 on the road surface collides with the share panel 20 and the collision load F is input to the share panel 20, the upward deflection of the share panel 20 can be reduced. That is, the share panel 20 is directly fastened to the lower wall 51 of each outer cross member 18. In this case, the distance La between the rear end 55 of the front outer cross member 18 and the front end 55 of the rear outer cross member 18 is the distance between the fulcrums of the bending moment of the share panel 20 at the time of the object collision. The rear end 55 of the front outer cross member 18 is indicated by the reference S1a in FIG. 2. The front end 55 of the rear outer cross member 18 is indicated by the reference S2a in FIG. 2.

On the other hand, according to the embodiment described above, the reinforcing member 60 is disposed between the share panel 20 and the lower wall 51 of the outer cross member 18. Both ends 75 of the lower surface of the reinforcing member body 61 in the vehicle front-rear direction are located outward of both ends 55 of the lower wall 51 of the outer cross member 18 in the vehicle front-rear direction. Therefore, the distance between the rear end 75 of the front reinforcing member body 61 and the front end 75 of the rear reinforcing member body 61 is the distance L between the fulcrums of the bending moment of the share panel 20 at the time of object collision. The rear end 75 of the front reinforcing member body 61 is indicated by the reference S1 in FIG. 2. The front end 75 of the rear reinforcing member body 61 is indicated by reference S2 in FIG. 2. In this case, the distance L between the fulcrums of the bending moment is shorter than that in the case where the share panel 20 is directly fastened to the outer cross member 18 (L<La). Therefore, when the object 110 collides with the share panel 20, the upward deflection of the share panel 20 can be reduced.

Further, according to the embodiment described above, as shown in FIG. 1B, the non-bolt regions 67, the front flanges 62, and the rear flanges 63 in the recesses 70 of the reinforcing member body 61 are welded to the share panels 20. When the object 110 collides with the share panel 20 from the lower side of the vehicle, as shown by the arrow F1 in FIG. 2, a force that the share panel 20 attempts to move from the reinforcing member 60 is generated. That is, the share panel 20 attempts to move toward the colliding object 110. However, according to the embodiment described above, since the reinforcing member 60 is welded to the share panel 20, it is possible to restrict movement of the share panel 20 with respect to the reinforcing member 60. Therefore, the upward deflection of the share panel 20 can be reduced.

Further, according to the embodiment described above, the center portion of the upper surface of the reinforcing member body 61 in the vehicle front-rear direction is a recess 70 that is thinned and extends in the vehicle width direction. Further, a front flange 62 and a rear flange 63 are present in front of and behind the non-bolt region 67 of the reinforcing member body 61. The front and rear of the bolt region 66 of the reinforcing member body 61 have no flanges. Therefore, the weight of the reinforcing member 60 can be reduced.

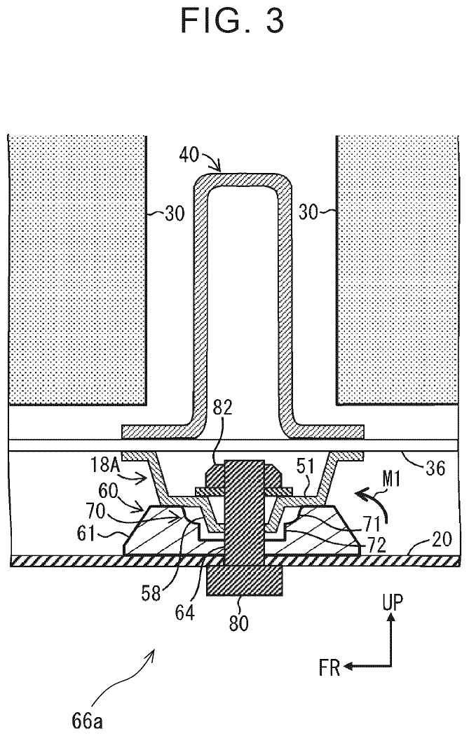

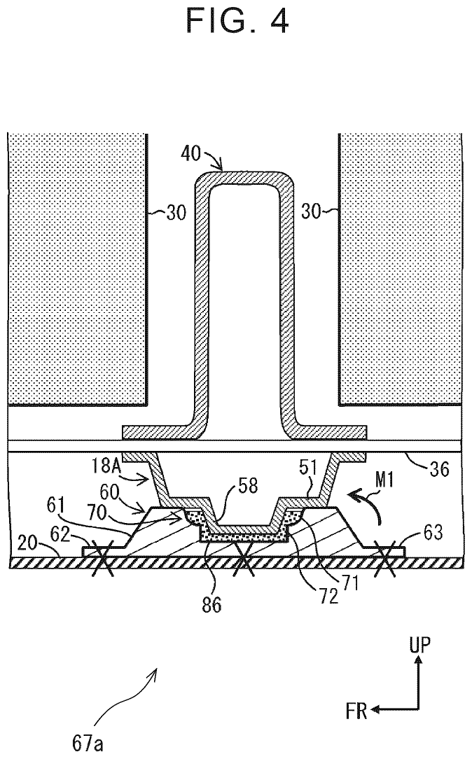

Next, another embodiment will be described. FIG. 3 is a cross-sectional view showing the bolt region 66a of the reinforcing member 60 in this alternative embodiment, and FIG. 4 is a cross-sectional view showing the non-bolt region 67a of the reinforcing member 60 in this alternative embodiment. In this embodiment, the lower wall 51 of the outer cross member 18A has a projection 58 protruding downward. A putty 86 (gap filler) is disposed in the recess 70 of the reinforcing member body 61 on the non-bolt region 67a. The shapes and other configurations of the reinforcing member 60 are the same as those of the embodiment described with reference to FIGS. 1A, 1B, and 2.

The projection 58 of the outer cross member 18A is formed by bending the lower wall 51 so as to have a hat-shaped cross section. The outer cross member 18A has the same or substantially the same cross-sectional profile along the vehicle-width direction.

The recess 70 of the reinforcing member body 61 includes a first recess 71 and a second recess 72. The second recess 72 is provided in the vehicle front-rear direction central portion (the lateral direction central portion of the reinforcing member body 61) of the first recess 71. The reinforcing member body 61 has the same or substantially the same cross-sectional shape along the vehicle width direction.

In the non-bolt region 67a of the recess 70 of the reinforcing member body 61, a putty 86 is disposed to fill between the inner surface of the recess 70 and the outer surface of the projection 58 of the outer cross member 18A. The projection 58 of the outer cross member 18A is detachable from the putty 86. This is achieved, for example, by applying a release agent to the outer surface of the projection 58 of the outer cross member 18A.

The operation and effect of this other embodiment will be described. As shown in FIG. 2, when the object 110 collides with the share panel 20 from the lower side of the vehicle and the share panel 20 is bent upward, a moment MI is generated in the reinforcing member 60. As a result, in the non-bolt region 67, the reinforcing member 60 moves with respect to the lower wall 51 of the outer cross member 18, as shown in the blow-out of FIG. 2. As a result, the upward deflection of the share panel 20 may increase.

However, according to this alternative embodiment, in the non-bolt region 67a, as shown in FIG. 4, the projection 58 of the outer cross member 18A enters the putty 86 of the recess 70 of the reinforcing member body 61. Therefore, it is possible to restrict the reinforcing member 60 from moving with respect to the lower wall 51 of the outer cross member 18. Therefore, the upward deflection of the share panel 20 can be reduced.

Further, a putty 86 (gap filler) is disposed between the inner surface of the recess 70 of the non-bolt region 67a of the reinforcing member body 61 and the outer surface of the projection 58 of the outer cross member 18A. Therefore, backlash between the non-bolt region 67a of the reinforcing member body 61 and the outer cross member 18A can be suppressed.

Further, the projection 58 of the outer cross member 18A is detachable from the putty 86. Therefore, by releasing the fastening of the bolt 80 between the outer cross member 18A and the share panel 20, the share panel 20 can be removed from the outer cross member 18A. Therefore, it is possible to improve the maintainability of the vehicle.

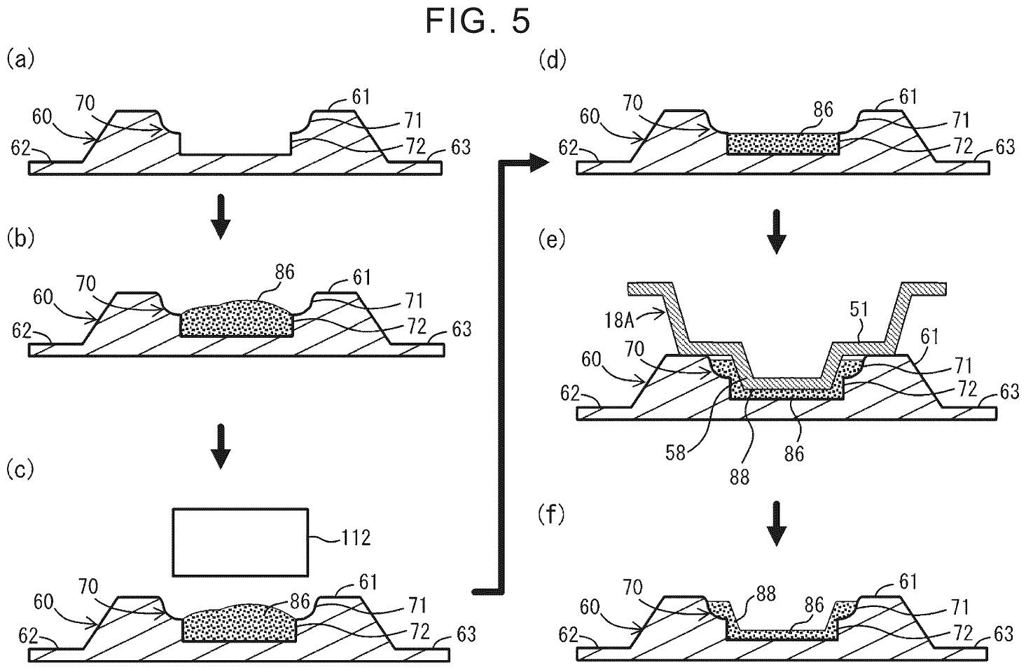

Here, a method of disposing the putty 86 in the recess 70 of the reinforcing member 60 at the time of manufacturing the vehicle will be described. FIG. 5 shows steps (a) to (f) of disposing the putty 86 in the recess 70 of the reinforcing member 60.

In step (a), the share panel 20 in which the plurality of reinforcing members 60 are welded is prepared.

In step (b), the softened putty 86 is poured into the recess 70 in the non-bolt region of the reinforcing member body 61. At this time, the blocking member may be disposed between the non-bolt region and the bolt region of the recess 70 so that the putty 86 does not flow into the recess 70 of the bolt region of the reinforcing member body 61.

In step (c), the spatula 112 is used to fill the putty 86 only in the second recess 72. Specifically, the spatula 112 is moved in the longitudinal direction of the reinforcing member 60 while being applied to the lower surfaces of both ends of the first recess 71. As a result, the putty 86 rising from the second recess 72 is removed.

In step (d), the putty 86 is cured to an extent that some flexibility remains. At this time, in the case where the blocking member is disposed in the above-described step (b), the blocking member may be removed.

In step (e), a release agent is applied to the projections 58 of the plurality of outer cross member 18A. Then, the share panel 20 in which the plurality of reinforcing members 60 (filled with putty) are welded to the plurality of outer cross member 18A is fastened by the plurality of bolts 80. At this time, the projections 58 of the outer cross member 18A enter the putties 86 of the second recesses 72 of the reinforcing members 60. The putty 86 will then cure. As a result, a recess 88 corresponding to the projection 58 of the outer cross member 18A is formed in the putty 86.

According to this embodiment, when the projection 58 of the outer cross member 18A enters the putty 86 of the second recess 72 of the reinforcing member body 61, the putty 86 overflowing from the second recess 72 can be received by the first recess 71. Therefore, it is possible to suppress the outward overflow of the putty 86 from the reinforcing member 60.

Further, a release agent is applied to the projections 58 of the plurality of outer cross member 18A. Therefore, as shown in step (f), during maintenance of the vehicle, the projection 58 of the outer cross member 18A is separated from the recess 88 of the putty, it is possible to remove the share panel 20 from the outer cross member 18A.

What is claimed is:

1. A vehicle bottom structure comprising:
a battery pack including a case that houses a battery module inside, the battery pack being mounted below a floor;
a plurality of outer cross members located below a bottom plate of the case and disposed at intervals in a vehicle front-rear direction; and
a share panel that is disposed below the outer cross members and covers the bottom plate of the case, wherein
each of the outer cross members has a hat-shaped cross section open upward, extends in a vehicle width direction, and is attached to an outer surface of the bottom plate of the case,
a reinforcing member extending in the vehicle width direction is disposed between a lower wall of each of the outer cross members and the share panel,
the share panel, the reinforcing members, and the lower walls of the outer cross members are stacked and fastened by bolts at intervals in the vehicle width direction,
the reinforcing member includes a body having bolt through holes through which the bolts pass, and a front flange and a rear flange projecting in the vehicle front-rear direction from a non-bolt region between the bolt through holes of the body that are adjacent to each other,
a central portion of the body of the reinforcing member in the vehicle front-rear direction includes a thinned upper surface that defines a recess extending in the vehicle width direction,
the non-bolt region in the recess of the body of the reinforcing member, the front flange, and the rear flange are welded to the share panel, and
both ends of a lower surface of the body of the reinforcing member in the vehicle front-rear direction are located outward of both ends of the lower wall of the outer cross member in the vehicle front-rear direction.

2. The vehicle bottom structure according to claim 1, wherein:
the lower wall of the outer cross member includes a projection that projects downward;
the recess of the body of the reinforcing member receives the projection of the outer cross member;
putty that fills a space between an inner surface of the recess of the body of the reinforcing member and an outer surface of the projection of the outer cross member is disposed in the non-bolt region in the recess; and
the projection of the outer cross member is detachable from the putty.

3. The vehicle bottom structure according to claim 2, wherein the recess of the body of the reinforcing member includes:
a first recess; and
a second recess provided in a central portion of the first recess in the vehicle front-rear direction.
